(19) United States
(12) Patent Application Publication
(10) Pub. No.: US 2009/0162492 A1
(43) Pub. Date: Jun. 25, 2009

(54) CONSUMABLE CANDY DRINKING STRAW AND A METHOD OF USING THE SAME

(76) Inventor: W. Frederick CONWAY, JR., New Albany, IN (US)

Correspondence Address: BERENATO, WHITE & STAVISH, LLC, 6550 ROCK SPRING DRIVE, SUITE 240, BETHESDA, MD, 20817, US

(21) Appl. No.: 11/959,661

(22) Filed: Dec. 19, 2007

(51) Int. Cl. A23G 3/50; A47G 21/18; G06Q 30/00

(52) U.S. Cl. 426/85; 426/390; 705/1

(57) ABSTRACT

A drinking straw including an elongated hollow consumable candy shell made from glassified sugar, said candy shell having a cylindrical shape through which liquid is transportable by applying a suction pressure to an end of the candy shell is disclosed herein.

### CROSS-REFERENCE TO RELATED APPLICATIONS AND CLAIMS TO PRIORITY

The present application claims priority from U.S. Provisional Patent Application No. 60/875,526 filed Dec. 19, 2006, the contents of which are incorporated herein by reference and to which priority is claimed.

### BACKGROUND OF THE INVENTION

1. Field of the Invention:

The present invention relates to a consumable candy drinking straw and a method of using the candy drinking straw to flavor and augment the flavor of a beverage.

2. Background of the Invention:

Candy is typically a single function and single use product. A consumer generally buys a candy product for the sole purpose of consuming the candy. There are various forms of candy, including hard candy, typically manufactured primarily from sugar and flavoring, chocolate, fruit juices, etc. Hard candy having a chocolate or flavored center is known. Regardless of its type, the candy typically is consumed when the candy is placed in the mouth of a consumer.

Fruit flavored beverages, sometimes called “smoothies,” have recently become popular. A typical smoothie has finely ground ice particles combined with flavoring. Finely ground fruit may be included as part of the flavoring in a smoothie. Due to its thick consistency, the smoothie typically is consumed with a straw or sometimes a straw that also functions as a spoon. The spoon or straw usually is made from plastic and allows the consumer to suck the smoothie from the cup or receptacle holding it.

Because the straw is formed of plastic, it imparts no flavor to the smoothie and merely allows the smoothie to be withdrawn from the receptacle. Because the straw is made from plastic it must be disposed of after the smoothie has been consumed. The plastic straw is usually of a very thin wall thickness and can cut the skin of the consumer.

There is a need for a candy product that can be used for purposes other than simple consumption. There is also a need for creative and fun candy products that have some utility other than their flavor.

### SUMMARY OF THE INVENTION

The present invention provides a drinking straw including an elongated hollow dissolvable candy shell made from twisted, glassified sugar and having a tubular configuration through which liquid is transportable by applying a suction to an end of the candy shell. Because the candy shell is placed in the mouth of the user, the candy slowly dissolves thereby providing a flavor sensation in the mouth of the user that can alter and/or augment the flavor of a smoothie or other beverage. The smoothie typically will be consumed before the candy straw is completely dissolved, thus allowing the consumer to also consume the straw afterward.

The candy shell may have a hollow cylindrical interior diameter of about 5 millimeters and a wall thickness of about 3.5 millimeters, thus having an outer diameter of about 12 millimeters.

Alternatively, the candy shell may have a hollow diameter of between 4 and 6 millimeters, a thickness of between 3 and 4 millimeters, and an outer diameter of between 10 and 14 millimeters.

The candy shell may include a plurality of twisted candy stripes diagonally twined with respect to a lengthwise axis of the candy shell. The twisted candy stripes include at least a first candy stripe spirally wound around the lengthwise axis of the candy tubular shell, and a second candy stripe spirally wound to complement the first candy stripe and to form the candy shell together therewith. The first and second candy stripes may have at least one cross sectional interface that extends from an inner surface of the candy shell to an outer surface of the candy shell. Alternatively and preferably the stripes do not actually go all the way through to the inner core as the stripes are put on the outside of the brick and then scrolled and pulled into rope.

The candy tubular shell includes a first end insertable into a beverage, and a is second end through which a suction is applied to move the beverage along an inner surface of the candy shell without breaking the shell. The candy shell preferably is a rigid, caramelized sugar, flavored composition that slowly dissolves in the mouth of the user and imparts the flavor to the consumer due to dissolution by the saliva in the mouth of the consumer.

The candy shell may be made from a mixture of sucrose, glucose syrup, maltose, water, citric acid, dextrin, at least one artificial flavor, and at least one artificial color. The sucrose, glucose syrup, and maltose constitute at least 95% by weight of the mixture. The candy shell may include a non-inverted sugar component and an inverted sugar component, the non-inverted sugar component being greater than the inverted sugar component. The inverted sugar component assists in preventing crystallization of the candy mass during manufacture of the candy straw. The candy shell may include citric acid providing a tartness to flavor the candy shell and also further causing the candy mass to contain inverted sugars to inhibit crystallization.

The present invention also provides a drinking straw made of a rigid tubular candy shell having a plurality of different twisted portions extending diagonally and intertwined to form the shell with respect to a lengthwise axis thereof.

The twisted portions include a first spiral portion and a second spiral portion having a shape that is complementary to the first spiral portion. The first and second spiral portions form a cylindrical candy shell together.

The candy shell has a predetermined thickness and each of the twisted portions may have the same predetermined thickness. Neighboring twisted portions may have at least one cross-sectional interface that extends from an inner surface of the candy shell to an outer surface of the candy shell. Alternatively and preferably the stripes do not actually go all the way through to the inner core as the stripes are put on the outside of the brick and then scrolled and pulled into rope.

The present invention also provides a method of using a candy drinking straw to consume a beverage. The method includes providing the candy drinking straw having a first end and a second end, providing a receptacle containing the beverage, inserting the first end of the candy drinking straw into the beverage in the receptacle, inserting the second end of the candy drinking straw into a mouth of a consumer, and applying a suction to the second end of candy drinking straw such that the beverage contained in the receptacle is transported from the first end of the candy drinking straw to the second of the candy drinking straw into the consumer's mouth.

The saliva in the mouth of the consumer may dissolve a portion of the second end of the candy drinking straw such that a flavor from the candy drinking straw is combined with a flavor from the beverage in the mouth of the consumer.

The method may include selecting a flavor of the candy drinking straw so as to complement the flavor of the beverage based on the consumer's taste preference. The beverage provided may include chunks of consumable material, such as ice, cookie, candy, etc., contained therein. The chunks of consumable material contained in the beverage are transported from the first end of the candy drinking straw to the second end of the candy drinking straw into the consumer's mouth. Due to the relatively large size of the irregularly shaped chunks, the drinking straw has a relatively larger inner diameter to allow the chunks to be drawn therethrough without clogging the straw and causing it to be unusable.

The present invention also provides a method of providing consumable candy drinking straws at a beverage sale establishment. The method includes providing a plurality of beverages at the beverage sale establishment. The beverages include at least a first beverage and a second beverage different from the first beverage. Hard candy straws of a plurality of flavors are also provided at the beverage sale establishment. The plurality of different flavors include at least a first flavor and a second flavor different from the first flavor. A suggested pairing between the plurality of different beverages and the hard candy straws of different flavors is provided. The first beverage is paired with the hard candy straw of the first flavor and the second beverage is paired with the hard candy straw of the second flavor. The suggested pairings are then offered to consumers.

A method of manufacturing a consumable candy straw is also provided. The method includes the step of producing a plurality of warm masses of candy having different colors or different flavors. The sugar masses are then twisted about the mold to form intertwined twisted portions of glassified sugar having different colors or different flavors into a hollow cylindrical tube. At least one section of the hollow cylindrical tube is then cut from the mold to form the consumable candy drinking straw.

### BRIEF DESCRIPTION OF THE DRAWINGS

FIG. 1A is a side elevational view of a candy drinking straw according to an embodiment of the present invention.

FIG. 1B is a side elevational view of a candy drinking straw according to another embodiment of the present invention.

FIG. 1C is a side elevational view of a candy drinking straw according to another embodiment of the present invention.

FIG. 2A is a cross-sectional view of the candy drinking straw of FIG. 1C taken along line A-A′ in FIG. 1C.

FIG. 2B is a cross-sectional view of an alternative embodiment comparable to the candy drinking straw of FIG. 1C.

FIG. 3 is a cross-sectional view of the candy drinking straw of FIG. 1C taken along line B-B′ in FIG. 1C.

FIG. 4 is a flow diagram of a general method of manufacturing a candy drinking straw according to another embodiment of the invention.

FIG. 5 is an elevational view of the candy straw of FIG. 1A inserted into a receptacle containing a beverage to be consumed.

FIG. 6A is a fragmentary side view of the swirl portions of the candy straw shown in FIG. 1B according to an embodiment of the present invention.

FIG. 6B is a fragmentary side view of the swirl portions of the candy straw shown in FIG. 1B according to another embodiment of the present invention.

### DESCRIPTION OF THE EMBODIMENT(S) OF THE INVENTION

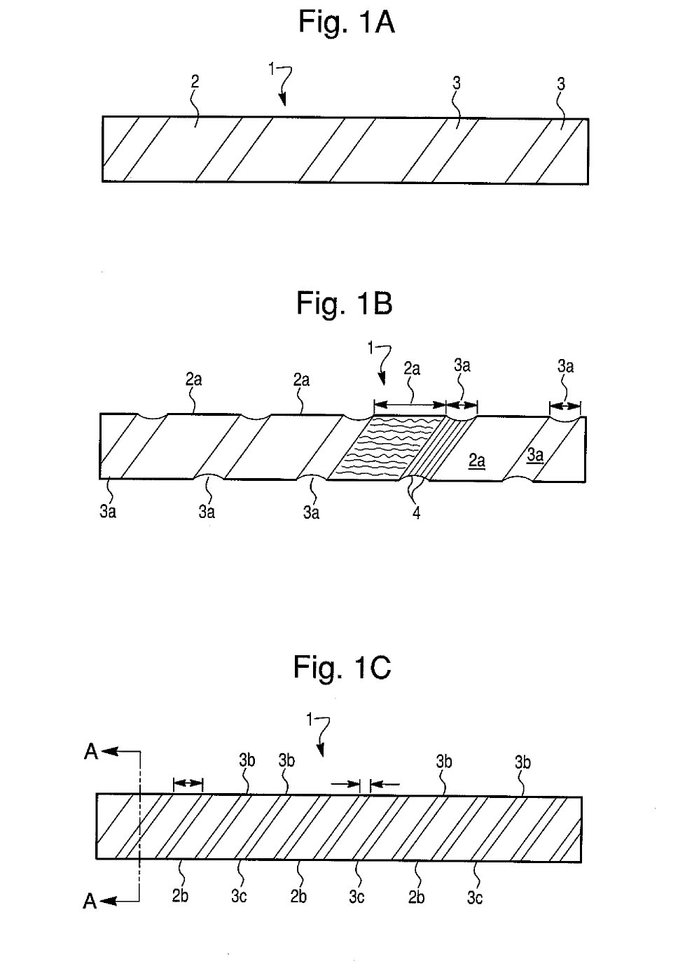

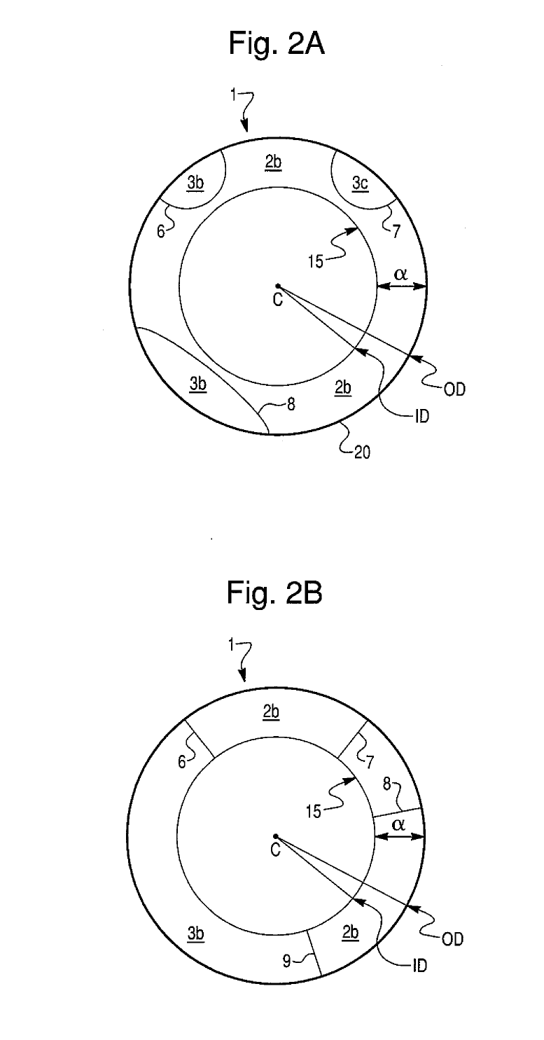

FIG. 1A illustrates a candy drinking straw 1 according to an embodiment of the present invention, and FIG. 2A illustrates a cross-sectional view of the candy drinking straw 1 of FIG. 1C. As best shown in FIG. 2A, the candy drinking straw 1 has a hollow cylindrical interior surface 15′. Straw 1 is a hollow, solid, dissolvable shell. Straw 1 can be used to consume beverages contained in a container, for example, milkshakes, smoothies, cold coffee drinks, ice cream floats, and other beverages. The candy drinking straw 1 is made of glassified sugar candy, and is sufficiently rigid to be inserted into a relatively thick beverage and to be able to transport heavy beverages from the receptacle to the mouth of the user. The glassified sugar may be made by heating a sugar solution to a temperature greater than or equal to 300 degrees Fahrenheit, forming the drinking straw by twisting strands of glassified sugar while the dewatered sugar solution is still hot/warm, and then allowing the sugar solution cool.

The candy drinking straw 1 enhances the flavor of whatever beverage is being enjoyed by a consumer. The candy drinking straw 1 maintains a stable solid state and is only relatively slowly dissolved from within by the beverage being transported therein. Additionally, a consumer's saliva dissolves a portion of the candy drinking straw 1, which adds flavor to the beverage being consumed. Once the consumer finishes the beverage, the candy drinking straw 1 may be consumed or may be re-used with another beverage.

The flavor of the candy drinking straw 1 may be selected to complement the beverage being consumed. For example, a cherry candy straw may be provided with a cola soft drink to provide a cherry/cola flavoring, a caramel candy straw may be provided with a vanilla milk shake or coffee drink, or a strawberry candy straw may be provided with a vanilla milk shake. Of course, other combinations are also possible. Thus, a beverage sale establishment, such as a coffee shop, an ice cream shop, a smoothie store, or a bar, which sells different beverages, may also sell a variety of different flavors of the candy drinking straw 1 so that consumers may select which flavored straw will complement and augment the flavor of their beverage. The added flavor of the candy drinking straw 1 may replace the need for additional ingredients in a beverage. For example, a candy drinking straw 1 of a particular flavor may be used in a coffee drink instead of an additional shot of flavored syrup. The above-mentioned beverage sale establishment may even provide a suggested pairing of beverages with candy drinking straws 1 of different flavors on a menu or drink list, much like some restaurants provide food and wine pairings. In this case, a candy drinking straw 1 of a first flavor may be paired or matched with a first beverage while a candy drinking straw 1 of a second different flavor may be paired or matched with a second beverage different from the first beverage.

Referring to FIG. 1A, the candy drinking straw 1 has a candy shell with a main, twisted candy portion 2 and a twisted candy portion 3 that is twisted with the main candy portion 2. Portions 2 and 3 extend longitudinally relative to the central axis of drinking straw 1. The main and twisted candy portions 2 and 3 may also be referred to as first and second twining portions 2 and 3. The main candy portion 2 and the twisted candy portion 3 may have different flavors, different colors, etc. Alternatively, the main and twisted candy portions 2 and 3 may have the same flavor or the same color.

The main and twisted candy portions 2 and 3 may have different textures or slightly different thicknesses to provide the candy drinking straw 1 with yet another aesthetically appealing feature as best shown in FIG. 1B. As best shown in FIG. 1B, the twisted candy portion 3a has a shiny and smooth finish while the main candy portion 2a has a textured non-smooth finish. This difference in texture may be created by varying the ingredients used to make the twisted portions 2a and 3a and/or by varying the twisting process used to twist the main and twisted candy portions 2a and 3a of the candy shell 1. The different textures of the stripes arises mainly because of the ingredients in the different colors of the stripes and how long the hot candy is pulled. The candy is pulled over and over again to make the candy smooth and all connected into one mass that is uniform and resembles a brick. The longer the candy is pulled, the more opaque it becomes. The pulling injects some air into the mass. The colored stripes may not be pulled as long as the mass of the candy brick before the hot candy masses (main candy portion and stripe portions) are put on the scrolling machine, and thus the different textures. Additionally, the twisted candy portion 3a may be formed with one or more swirl portions 4 defined in an outer surface thereof. The swirl portion 4 may be a recess or a protrusion defined in the outer surface of the twisted candy portion 3a that extends around the twisted candy portion 3a in the same direction thereof, as best shown in FIG. 1B. That is, the swirl portion 4 may be a continuous surface irregularity, e.g., a recess or a protrusion, formed in a major surface of the twisted candy portion 3a. As best shown in FIGS. 6A and 6B, the swirl portion may be a protrusion 4a or a recess 4b. Referring to FIG. 1B, the swirl portion 4 may have an irregular surface including, for example, a recess or a protrusion, in twisting portion 3a.

Referring to FIG. 1A, the arrangement of the main candy portion 2 and the twisted candy portion 3 of the candy shell 1 provides an aesthetically appealing drinking straw design while providing the consumer with the choice of different flavors and colors of the main and twisted candy portions 2 and 3. The colors of the main candy portion 2 and the twisted candy portion 3 may be selected to match their respective flavors. For example, a candy drinking straw 1 having a caramel flavoring may have the colors of tan and caramel brown twined together Structurally, the intertwining of the twisted candy portion 3 with the main candy portion 2 reinforces and strengthens the candy shell 1 to make the candy drinking straw 1 more difficult to crack or break during transport, insertion, or use. Preferably, each twisted portion 2 has a uniform circumferential width and thickness.

While only one twisted portion 2 is illustrated in FIG. 1A, preferably there are a plurality of twisted candy portions 3b and 3c arranged with the main candy portion 2b circumferentially disposed about straw 1 as best shown in FIG. 1C. As can be seen from FIG. 1C, each of the main candy portion 2b and the twisted candy portions 3b and 3c have a uniform circumferential thickness to provide a consistent spiraling appearance to the drinking straw 1, regardless of the side or angle from which the drinking straw 1 is viewed. The circumferential widths of the main candy portion 2b and the twisted candy portions 3b and 3c are denoted by double sided arrows A. As best shown in FIG. 1C, the circumferential widths of the main candy portion 2b and the twisted candy portions 3b and 3c may all be different from one another. This arrangement makes the candy drinking straw 1 shown in FIG. 1C more aesthetically appealing. Referring to FIG. 1A, it should be understood that although the candy drinking straw 1 is described as having the twisted candy portion 3, more than one twisted candy portion may be used in alternative embodiments of the invention. For example, the candy drinking straw 1 may be a single color/flavor solid candy shell. In another example, the candy drinking straw 1 may have several twisted candy portions 3, each providing a different color candy and/or a different candy flavor in addition to the main candy portion 2. Even in this embodiment, the main candy portion 2 is twisted and formed from a warm sugar mass. In the course of development of straw 1, efforts to extrude a warm candy mass to form a straw failed. The extruded mass is incapable of maintaining an open, substantially uniform inner diameter straw to permit consumption of the relatively thick smoothie beverage.

As best shown in FIG. 2A, a cross-section of the candy drinking straw 1 of FIG. 1C includes a hollow cylinder 15 having a thickness (x), a lengthwise center axis (c), an inner diameter of the candy shell (ID), and an outer diameter of candy shell (OD). The thickness (x) of the candy drinking straw 1 is such that the candy shell does not collapse during beverage consumption and is large enough to permit the relatively thick smoothie mix, including any fruit chunks, to be easily drawn therethrough. For example, even when a consumer is drinking a thick beverage (e.g., a milkshake) requiring the consumer to apply a relatively large suction to an end of the candy drinking straw 1 in order to move the beverage up through the candy straw 1, the dimensions and rigidity of the candy straw 1 are such that the candy straw 1 remains intact and stable. Hence, the candy shell I will not collapse when suction is applied.

In an exemplary embodiment of the invention, the outer diameter (OD) of the candy drinking straw 1 may be between 10 to 14 millimeters (mm), the inner diameter (ID) may be between 4 to 6 mm, and the thickness (x) of the candy straw 1 may be between 3 to 4 mm. More particularly, the candy shell 1 may be made such that the outer diameter (OD) is about 12 mm, the thickness (x) of the candy shell 1 is about 3.5 mm, and the inner diameter (ID) of the candy shell 1 is about 5 mm.

By comparison, most conventional plastic drinking straws have an inner diameter of about 7.5 mm. Other dimensions may also be used with embodiments of the present invention as long as the thickness (x) of the candy drinking straw 1 is large enough to withstand suction applied by the consumer in order to transport thick/heavy beverages without breakage. Additionally, the inner diameter (ID) of the candy straw 1 may be is large enough such that a thick milk shake, cookie crumbs, pieces of fruit, etc. may be transported therethrough by the suction applied by the consumer.

It can also be seen from the cross-section of the candy drinking straw 1 shown in FIG. 2A that the candy portions 2b, 3b, and 3c divide the cross-section of the candy straw 1. The candy portions 2b, 3b, and 3c have complementary spiral shapes that together form the candy straw 1 substantially without overlap in the radial direction extending outward from the lengthwise center axis (c) of the candy drinking straw 1.

As best shown in FIG. 2A, preferably the stripes 3 have a thickness in the radial direction less than the thickness of the main candy portions 2. Thus, the stripes 3 are embedded in candy portions 2. The stripes 3 are entwined about the candy portions 2. The stripes 3 may have a width in the axial direction which is less than the width of the candy portions 2. The exact widths of the portions 2 and 3 is a function of aesthetics and flavoring of the stripes 3 and the candy portions 2. As best shown in FIG. 2A, the candy portions 3b and 3c are embedded in the candy 2b. The candy portions 2b have a thickness of x, as illustrated by the double arror in FIG. 2A and the candy portions 3b and 3c have a thickness of less than x. Each of the stripes 3b and 3c has an interface 6, 7 and 8, respectively, with the main candy portion 2b. The interfaces 6, 7 and 8 are arcs extending inwardly from the outer surface 20.

Alternatively, as shown in the cross-section shown in FIG. 2B, four interfaces (6, 7, 8, 9) extend from the inner diameter (ID) to the outer diameter (OD). The interfaces 6 and 9 extend between the main candy portion 2b and the twisted candy portion 3b. The interfaces 7 and 8 extend between the main candy portion 2b and the twisted candy portion 3c. As best shown in FIG. 2B, the main candy portion 2b includes two candy is strips, each intertwined between the twisted candy portions 3b and 3c. Thus, although not shown in FIGS. 1C and 2B, if the candy portions 2b, 3b, and 3c were removed from one another, each would form a spiral shape complementary to the others. The shapes of the twisted candy portions 2b, 3b, and 3c are a product of how the candy drinking straws 1 are manufactured. It will be appreciated that although the main candy portion 2b is shown in FIG. 2B as being intertwined with two or more twisted candy portions 3b and 3c, a single twisted candy portion 3 may be combined with the main candy portion 2 to form the candy straw 1, as best shown in FIG. 1A. In this case, there are only two interfaces (not shown) between the main and twisted candy portions 2 and 3. Additionally, although the interfaces 6 to 9 are shown as defined lines where the main candy portion 2b meets the twisted candy portions 3b and 3c, respectively, it will be appreciated by one of ordinary skill in the art that some blending between the colors of the twisted candy portions 2b, 3b, and 3c may occur near the interfaces 6 to 9.

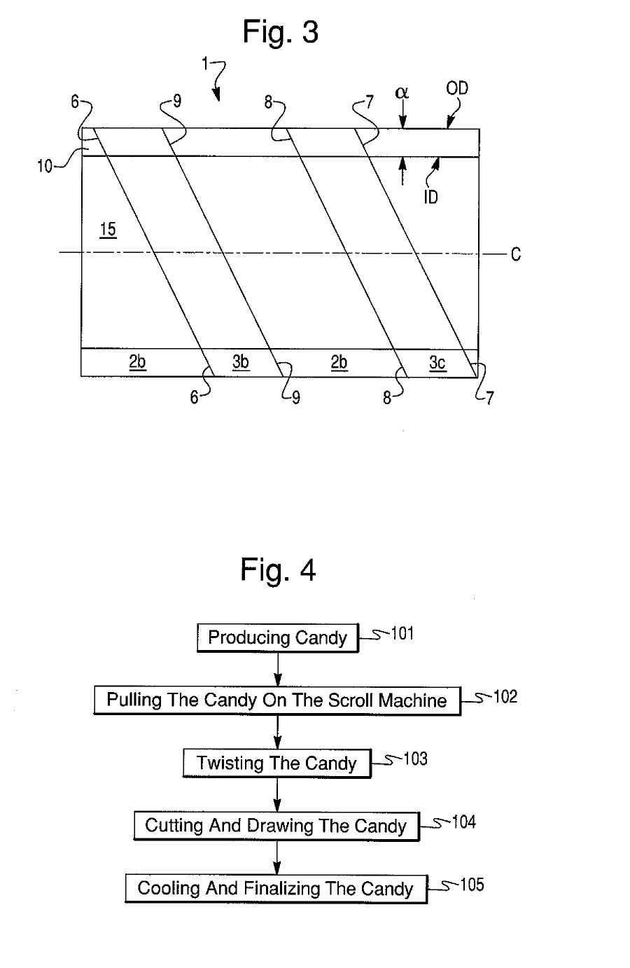

As best shown in FIG. 3, the cross-section of the candy drinking straw 1 taken along line B-B′ in FIG. 1C includes the main candy portion 2b intertwined with the twisted candy portions 3b and 3c. These candy portions 2b, 3b, and 3c meet at and are joined along the interfaces 6 to 9 into a unitary, integral form suitable for use as a straw.

As best shown in FIG. 3, a candy straw 10 is formed from combining the spiral shapes of the main candy portion 2b and the twisted candy portions 3b and 3c. The thickness (x), the inner diameter (ID), and the outer diameter (OD) are also shown in FIG. 3. Preferably the portions 2b, 3b and 3c have a uniform width extending longitudinally along the straw 1.

It should be understood that the elements of the candy drinking straw 1 shown in FIGS. 1A, 1B, 1C, 2A, 2B, and 3 are not drawn to scale, and some of the dimensions of these components have been exaggerated for clarity.

It is believed by the inventor that prior to the present invention; there was no other method of forming a hard candy cylinder suitable as a straw for use with a beverage, particularly a thick beverage like a smoothie. It is also believed by the inventor that conventional methods were unable to produce a hard candy straw of caramelized/glassified sugar that is capable of being used to consume a variety of beverages. Consequently, it is believed that there were no other candy drinking straws made from caramelized/glassified sugar available to consumers.

For example, conventional extrusion processes were not suitable to produce a hard candy drinking straw usable to consume a variety of beverages; because molten candy cannot be extruded to form a hard candy straw with a tubular portion. Furthermore, one of ordinary skill in the art will appreciate that conventional extrusion processes would also be incapable of forming the twisted candy portions 2 and 3 of the candy drinking straw 1 shown in FIGS. 1A, because the twisted candy portions 2 and 3 extend spirally in a diagonal direction with respect to the lengthwise center axis (c) of the candy drinking straw 1. Extrusion processes do not provide a manner of forming the candy portions 2 and 3 twisted diagonally with respect to the lengthwise center axis (c). Moreover, extrusion processes are unable to provide different surface textures and/or thicknesses to the main and twisted candy portions 2a and 3a best shown in FIG. 1B. The method shown in FIG. 4 makes it possible to form a hard, glassified candy into a tubular portion suitable for the candy straw 1 shown in FIGS. 1A through 3. FIG. 4 illustrates a general method of manufacturing a candy drinking straw according to an embodiment of the invention. The method of FIG. 4 includes step 101 in which candy is produced and cooked, step 102 in which the candy is processed on a scroll machine to make a hollow tube of candy on a conical mold and a cord that is connected to a narrow end of the conical mold, step 103 in which the candy is twisted about the cord to give the hollow candy tube a swirl or twining, step 104 in which the hollow, twisted candy tube is removed from the cord and cut into segments, and step 105 in which the segments of the hollow candy tube are cooled and finalized into candy drinking straws. The cord defines the hollow interior portion of the candy drinking straw 1. Thus, when step 103 is performed, the candy is twisted about the cord by applying a diagonal force along the surface of the candy to form two or more twisted candy portions 2 and 3. The twisting may be performed using first and second rotating belts, for example, that apply pressure to the candy in different directions. The rotating belts may be made differently to make the characteristics, for example, finish or thickness, of the main and twisted candy portions 2a and 3a slightly different as best shown in FIG. 1B.

Step 101 transforms the liquid candy into a semi-solid mass of candy when it cools after cooking because the inverted sugar and other components are mixed with water that is driven off by cooking the mix at about 300° F. In the semi-solid state, the mass of candy can be processed, molded, shaped, etc. into the candy drinking straw 1 in steps 102-104. The candy produced in step 101 is made from a mixture of sugar, glucose syrup, maltose, distilled water, citric acid, dextrin, artificial flavors, and artificial colors. The sugar preferably is sucrose, which is made of one molecule of glucose connected to one molecule of fructose. The maltose preferably is fructose derived from a plant other than sugar cane, for example, corn. The glucose and maltose are both inverted sugars that do not crystallize. The amount of sucrose (non-inverted sugar) is slightly greater than the amount of glucose and maltose (inverted sugars) to make hard candy. Additionally, the total concentration of sugars, including sucrose, glucose syrup, and maltose, should be about 95% percent by weight or greater of the total mixture for it to solidify when the mixture is cooled. Water is used to dissolve the sugars in step 101. Most of the water is boiled off during the preparation of the sugar solution to achieve the proper consistency and so that the sugar can form a solid when it cools.

The candy drinking straw 1 is made of caramelized sugar. Caramelization, also know as “glassification,” occurs when a sugar is dissolved in water at a high concentration, and is then heated to a very high temperature to boil off much of the water. When the solution cools it turns into a relatively solid mass, which is a type of “glass.” The molecules that make up sugar form a solid very quickly before they have time to arrange themselves in a crystal lattice. Thus, the candy drinking straw 1 made from inverted sugars to preclude crystallization. The citric acid makes the sugar slightly tart for creating a stronger more prominent flavor and for further enhancing the amount of inverted sugar. Thus, even if the candy drinking straw 1 is used with a beverage having a strong taste with a tendency to overpower the taste of regular candy, the citric acid adds a strong tart flavor that strengthens the flavor of the candy drinking straw 1 to ensure that the beverage flavor does not completely mask the flavor of the candy drinking straw 1. As a result, the flavors of the beverage and the candy drinking straw 1 may be tasted in desirable proportions. It will be appreciated that the tartness of the candy drinking straw 1 may be varied based on the flavor of the candy drinking straw 1 to be produced.

Step 101 produces a plurality of warm masses of candy which are pulled together in step 102. The plurality of warm masses of candy each have a different color and/or a different flavor and are ultimately formed into the main candy portion 2 and the twisted candy portion(s) 3 of the drinking straw 1 shown in FIGS. 1A to 3. The warm masses may be formed of different ingredients to provide the main and twisted candy portions 2a and 3a different surface textures, as best shown in FIG. 1B. In the method described above with reference to FIG. 4, the mass of sugar composition is scrolled along a conical mold about a cord in step 102 to form a candy straw shape with consistent dimensions suitable to transport a variety of different beverages. Initially in step 102, the masses of different color candy may be arranged longitudinally along the conical mold. The scrolling process rolls these masses along the conical mold to form a unitary mass of candy having strips extending longitudinally. As a result of the pulling step 102 using the conical mold and the cord, a hard candy drinking straw shape formed of intertwined portions 2 and 3 can be achieved. The twisted portions 2 and 3 are formed while the mass of sugar is arranged on the cord in step 103. That is, different color masses of sugar arranged around the cord are twisted around the cord in step 103 to form the candy shell 1 shown in FIGS. 1A through 3. The twisting of the different masses may be varied so as to provide the main and twisted candy portions 2a and 3a best shown in FIG. 1B with different surface textures. For example, the surfaces used to apply twisting forces to the different color masses may be made different from each other to make the surfaces of the main and twisted candy portions 2a and 3a different. The method of FIG. 4 corresponds to the method(s) described in U.S. Provisional Patent Application No. 60/949,548, the contents of which are incorporated is herein by reference.

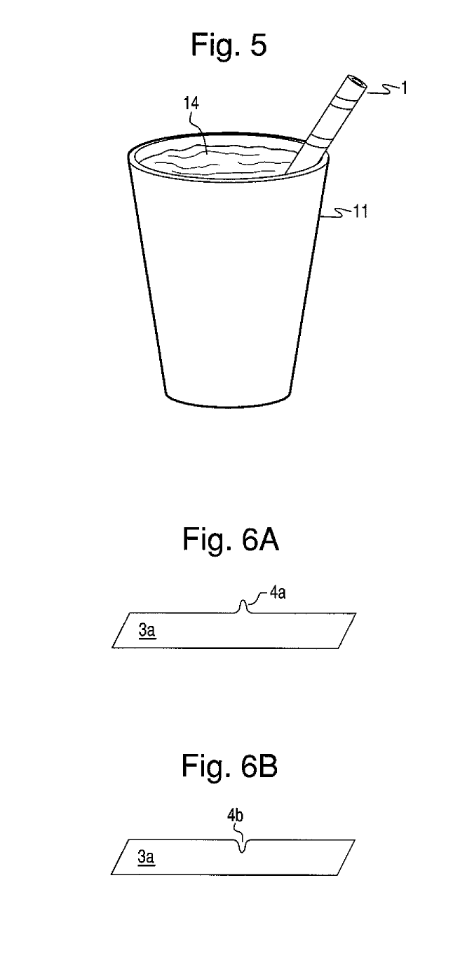

FIG. 5 is an elevational view of the candy straw 1 of FIG. 1A inserted into a receptacle 11 containing a beverage 14 to be consumed.

Although embodiments of the present invention have been shown and described, it will be appreciated by those skilled in the art that changes may be made in these embodiments without departing from the principles and spirit of the invention, the scope of which is defined in the appended claims and their equivalents.

What I claim is:

1. A drinking straw, comprising:
an elongated hollow consumable candy shell made from glassified, intertwined spiral sugar strips, said candy shell having a hollow tubular configuration with openings oppositely disposed at ends through which liquid is transportable by applying a suction to an end of the candy shell.

2. The drinking straw of claim 1, wherein the candy tubular shell has a hollow cylindrical interior diameter of about 5 millimeters.

3. The drinking straw of claim 1, wherein the candy tubular shell has a thickness of about 3.5 millimeters.

4. The drinking straw of claim 1, wherein the candy tubular shell has an outer diameter of about 12 millimeters.

5. The drinking straw of claim 1, wherein the candy tubular shell has a hollow diameter of between 4 and 6 millimeters, a thickness of between 3 and 4 millimeters, and an outer diameter of between 10 and 14 millimeters.

6. The drinking straw of claim 1, wherein the candy tubular shell comprises a plurality of twisted candy stripes diagonally twined with respect to a lengthwise axis of the candy tubular shell.

7. The drinking straw of claim 1, wherein the twisted candy stripes comprise at least:
a first candy stripe spirally wound around the lengthwise axis of the candy tubular shell; and
a second candy stripe spirally wound to complement the first candy stripe and to form the candy shell together therewith, the second candy stripe being embedded in said first candy stripe and said first and second stripes having different colors and/or flavors.

8. The drinking straw of claim 1, wherein the candy tubular shell comprises:
a plurality of circumferentially spaced candy strips, said strips having a uniform circumferential width and a uniform thickness, and some of said strips are a different color or a different flavor.

9. The drinking straw of claim 1, wherein the candy shell comprises a rigid, caramelized dissolvable sugar composition.

10. The drinking straw of claim 1, wherein the candy shell is formed of a mixture comprising sucrose, glucose syrup, maltose, water, citric acid, dextrin, at least one artificial flavor, and at least one artificial color.

11. The drinking straw of claim 10, wherein the sucrose, glucose syrup, and maltose constitute at least 95% by weight of the mixture.

12. The drinking straw of claim 1, wherein the candy shell comprises a non-inverted sugar component and an inverted sugar component, said non-inverted sugar component being greater than said inverted sugar component.

13. The drinking straw of claim 1, wherein the candy shell comprises citric acid.

14. A drinking straw made of a rigid tubular candy shell formed from a plurality of different intertwined twisted portions extending longitudinally and about the shell with respect to a lengthwise axis thereof.

15. The drinking straw of claim 14, wherein the twisted portions comprise a first spiral portion and a second spiral portion having a shape that is complementary to the first spiral portion, the first and second spiral portions forming a cylindrical candy shell together.

16. The drinking straw of claim 14, wherein the candy shell has a predetermined thickness and at least some of the twisted portions have the same predetermined thickness.

17. The drinking straw of claim 16, wherein neighboring twisted portions have at least one cross-sectional interface that extends from an inner surface of the candy shell to an outer surface of the candy shell.

18. The drinking straw of claim 14, wherein the tubular candy shell has a hollow diameter of between 4 and 6 millimeters, a thickness of between 3 and 4 millimeters, and an outer diameter of between 10 and 14 millimeters.

19. The drinking straw of claim 14, wherein the tubular candy shell is made from glassified sugar.

20. The drinking straw of claim 14, wherein the tubular candy shell is made from non-crystallized sugar.

21. The drinking straw of claim 14, wherein the tubular candy shell contains more non-inverted sugar than inverted sugar.

22. The drinking straw of claim 14, wherein the different twisted portions have different finishes and/or different thicknesses.

23. The drinking straw of claim 22, wherein at least one of the twisted portions comprises a surface irregularity extending along a length of the at least one twisted portion, said surface irregularity comprising one of a recess and a protrusion.

24. A method of using a candy drinking straw to consume a beverage, the method comprising:
providing the candy drinking straw having a first end and a second end;
providing a receptacle containing the beverage;
inserting the first end of the candy drinking straw into the beverage in the receptacle;
inserting the second end of the candy drinking straw into a mouth of a consumer; and
applying a suction to the second end of candy drinking straw such that the beverage contained in the receptacle is transported from the first end of the candy drinking straw to the second of the candy drinking straw into the consumer's mouth.

25. The method of claim 24, wherein the mouth of the consumer dissolves a portion of the second end of the candy drinking straw such that a flavor from the candy drinking straw is combined with a flavor from the beverage in the mouth of the consumer.

26. A method of providing consumable candy drinking straws at a beverage sale establishment, the method comprising:
providing a plurality of beverages at the beverage sale establishment, the beverages including at least a first beverage and a second beverage different from the first beverage;
providing hard candy straws of a plurality of flavors at the beverage sale establishment, the plurality of different flavors including at least a first flavor and a second flavor different from the first flavor;
providing a suggested pairing between the plurality of different beverages and the hard candy straws of different flavors, the first beverage being paired with the hard candy straw of the first flavor and the second beverage being paired with the hard candy straw of the second flavor; and
offering the suggested pairings to consumers.

27. A method of manufacturing a consumable candy straw, said method comprising the steps of:
producing a plurality of warm masses of candy having different colors or different flavors;
twisting the sugar masses to form intertwined twisted portions of glassified sugar having different colors or different flavors into a hollow cylindrical tube; and
cutting at least one section of the hollow cylindrical tube from the mold to form the consumable candy drinking straw.
